(19) United States
(12) Patent Application Publication
(10) Pub. No.: US 2005/0063524 A1
(43) Pub. Date: Mar. 24, 2005

(54) Communication system and method

(75) Inventors: Michael T. McKibben, Columbus, OH (US); Jeffrey R. Lamb, Westerville, OH (US); Wayne Dugal, Dublin, OH (US)

Correspondence Address: AMIN & TUROCY, LLP, 1900 EAST 9TH STREET, NATIONAL CITY CENTER, 24TH FLOOR,, CLEVELAND, OH, 44114, US

(73) Assignee: Leader Technologies, Inc., Westerville, OH (US)

(21) Appl. No.: 10/979,611

(22) Filed: Nov. 2, 2004

Related U.S. Application Data
(63) Continuation-in-part of application No. 10/731,906, filed on Dec. 10, 2003.
(63) Continuation-in-part of application No. 10/732,744, filed on Dec. 10, 2003.
(60) Provisional application No. 60/516,307, filed on Nov. 3, 2003.
(60) Provisional application No. 60/432,257, filed on Dec. 11, 2002.
(60) Provisional application No. 60/432,255, filed on Dec. 11, 2002.

(51) Int. Cl. H04M 11/00; H04M 3/42

(52) U.S. Cl. 379/88.18

(57) ABSTRACT

A voice response component that interfaces to a digital telephone communications system to, generally, communicate voice messages, and more specifically, to provide call conferencing. The voice response component includes a non-voice communications bus, and a session component that interfaces to the voice response component to manage processing of the voice messages by routing the voice messages along the non-voice communications bus to facilitate managing a call session.

### CROSS-REFERENCE TO RELATED APPLICATIONS

This application claims the benefit of U.S. Provisional Patent application Ser. No. 60/516,307 entitled “COMMUNICATION SYSTEM AND METHOD” and filed Nov. 3, 2003. This application is a continuation-in-part of the following pending U.S. patent application Ser. No. 10/731,906 entitled “CONTEXT INSTANTIATED APPLICATION PROTOCOL” filed Dec. 10, 2003, which claims the benefit of U.S. Provisional Application Ser. No. 60/432,257 entitled “CONTEXT INSTANTIATED APPLICATION PROTOCOL” filed Dec. 11, 2002; and Ser. No. 10/732,744 entitled “DYNAMIC ASSOCIATION OF ELECTRONICALLY STORED INFORMATION WITH ITERATIVE WORKFLOW CHANGES” filed Dec. 10, 2003, which claims the benefit of U.S. Provisional Application Ser. No. 60/432,255 entitled “METHOD FOR DYNAMIC ASSOCIATION OF ELECTRONICALLY STORED INFORMATION WITH ITERATIVE WORKFLOW CHANGES” filed Dec. 11, 2002. The entireties of the above-noted applications are incorporated by reference herein.

### TECHNICAL FIELD

This invention relates to communication systems, and more specifically, web managed teleconferencing telephony systems and methods.

### BACKGROUND OF THE INVENTION

The advent of global communications networks such as the Internet have facilitated numerous collaborative enterprises. In addition to basic e-mail exchanges and intercommunications, such communications networks offer the capability to provide conferencing arrangements whereby many customers can be bridged together on a media conference connection. Individuals and business people seek to communicate with each other, obtain useful information, interact commercially and entertain themselves in an increasingly mobile society. In order to fulfill these needs, one requires the capability to send and receive messages, access information and entertainment, conduct business transactions, organize daily schedules and stay in touch with homes and offices from almost anywhere, at any time, as easily as making a telephone call.

One method of collaborative communications is via a conference call. A conference call session utilizes a bridge device or system that allows several connection endpoints to be connected together to establish a communications conference. Communications conferences may include voice, video, and an assortment of other media streams. Historically, each session participant is contacted at the appropriate time to establish a communication path between a conference call bridge and the participant's customer station. The participant is then informed that he or she is wanted for a conference call and then added to the bridge where the participant can talk with the other participants. This type of an arrangement is under the control and supervision of an operator or attendant who can answer, add, or disconnect individual conferees to the bridge with minimal interference to the other conferees connected.

More recently, systems have allowed participants to enter and leave a conference without interaction with a physical attendant. In the prior art, control of conference bridge operator functions such as deleting or intercepting a participant was accomplished via manual operation by way of a console. Such capability further restricted the implementation of optional functions to operations manually selectable by a human attendant operator.

An improvement over the above is a conference call service, which is offered by a third party to set up a conference call between multiple parties. Such services can require an originator to contact a conference call coordinator with the date and time of the call and the telephone numbers (and names) of the participants. The coordinator initiates the conference at the appropriate time by contacting and connecting the participants. This frees the originator from manually dialing the telephone numbers of the participants, but requires yet another human operator to coordinate the call.

Advances in wireless telecommunication technologies have led to the development of portable wireless such as personal digital assistants (PDAs), cellular telephones, and messaging devices that have enabled the growth of paging and cellular telephone networks. Portable computers as notebooks and laptops with wired and wireless capabilities have further allowed highly mobile professionals to connect to networks from virtually any location, as well as to access on-line information and electronic mail services while traveling worldwide. The problem of accessing and processing all of the information available from communication devices, networks, and services is particularly acute for mobile business professionals. Thus, the need to provide conferencing capabilities at a reasonable cost becomes even more imperative.

High-end prior art teleconferencing systems can provide a number of conferencing capabilities. However, such systems can be an enormous cost to businesses who desire such options and capabilities. Thus, small businesses are left dealing with legacy systems that have limited teleconferencing capabilities. Moreover, such low-end conventional systems do not provide adequate security as the more costly systems. Despite the proliferation of communication devices and the development of the Internet, significant barriers remain to fulfilling user needs for access to and management of personal, professional and public information.

Thus, there exists a need for an improved conferencing system and methodology that can provide advanced features of high cost systems, but for significantly less cost.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention is directed to telephony systems and methods. The invention is preferably implemented in software that controls various telephony tasks.

The invention disclosed and claimed herein, in one aspect thereof, comprises a system that facilitates call conferencing. A voice response component that interfaces to a digital telephone communications system to communicate voice messages, the voice response component including a non-voice communications bus. The system further includes a session component that interfaces to the voice response component to manage processing of the voice messages by routing the voice messages along the non-voice communications bus to facilitate managing a call session.

In another aspect of the subject invention, a computer telephony interface component is provided that facilitates user interaction at a higher level to initiate call conferencing.

In yet another aspect thereof, an access component facilitates access to the call conferencing system via a browser-based system, including a wired computer, wireless computer, portable communications device (e.g., a cellular telephone, PDA, and messaging device.

To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 illustrates a call session system in accordance with the subject invention.

FIG. 2 illustrates a methodology of call conferencing in accordance with the invention.

FIG. 3 illustrates more detailed system diagram of the telephone call processing system of the subject invention.

FIG. 4 illustrates a methodology of performing call conferencing in accordance with the invention.

FIG. 5 illustrates a methodology of processing greetings in accordance with the invention.

FIG. 6 illustrates a methodology of connecting a conference participant to the appropriate conference call session in accordance with the invention.

FIG. 7 illustrates a methodology of creating a new conference call in accordance with the invention.

FIG. 8 illustrates a methodology of processing a received facsimile in accordance with the invention.

FIG. 9 illustrates a methodology of capturing incoming information in accordance with the invention.

FIG. 10 illustrates a methodology of processing an e-mal address book in accordance with the invention.

FIG. 11 illustrates a methodology of managing a conference call session in accordance with the invention.

FIG. 12 illustrates a methodology of managing a session by a host in accordance with the invention.

FIG. 13 illustrates a methodology of managing a conference call session in a no-host manner in accordance with the invention.

FIG. 14 illustrates a general system configuration of the present invention.

FIG. 15 illustrates a sample PIN card that can be used to access a conference call in accordance with the invention.

FIG. 16 illustrates a block diagram of a computer operable to execute the disclosed architecture.

FIG. 17 illustrates a schematic block diagram of an exemplary computing environment in accordance with the subject invention.

### DETAILED DESCRIPTION OF THE INVENTION

The invention is now described with reference to the drawings, wherein like reference numerals are used to refer to like elements throughout. In the following description, for purposes of explanation, numerous specific details are set forth in order to provide a thorough understanding of the subject invention. It may be evident, however, that the invention can be practiced without these specific details. In other instances, well-known structures and devices are shown in block diagram form in order to facilitate describing the invention.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

While certain ways of displaying information to users are shown and described with respect to certain figures, those skilled in the relevant art will recognize that various other alternatives can be employed. The terms “screen,” “web page,” and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

The present invention is directed to telephony systems and methods. The invention is preferably implemented in software that controls various telephony tasks.

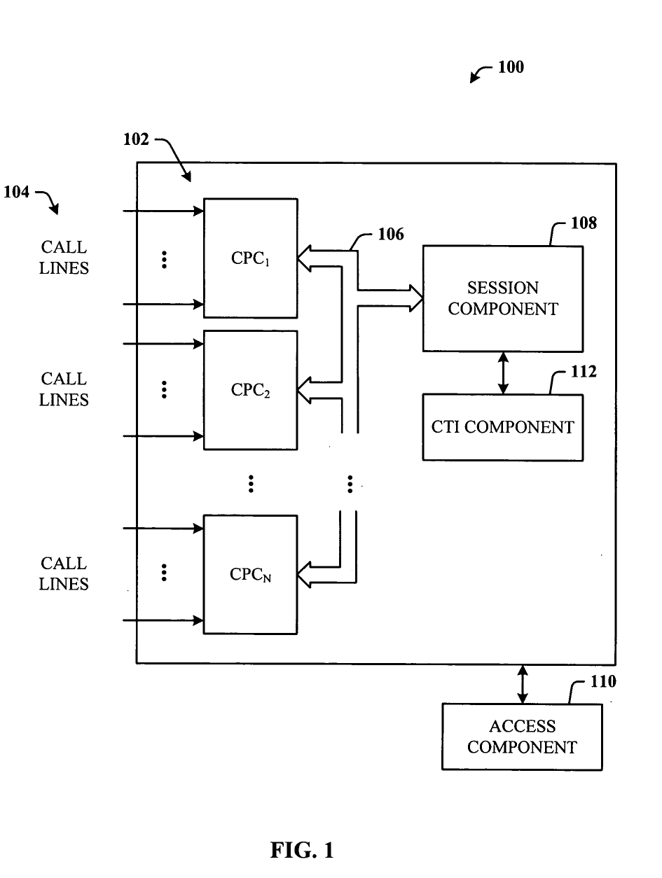

Referring now to FIG. 1, there is illustrated a call session system 100 in accordance with the subject invention. The system 100 includes one or more call processing components 102 (denoted CPC₁, CPC₂, . . . , CPC_{N}) that provide the capability to receive and transmit calls via call lines 104 (e.g., as provided by digital T1 and E1 communications architectures), and process signals and data for at least the management of call conferencing. The one or more call processing components 102 intercommunicate control signals and data across a non-voice communications bus 106. In accordance with a novel aspect of the subject invention, a session component 108 resides on the bus 106 in communication with the one or more call processing components 102 to facilitate routing of one or more of the calls across the non-voice communications bus 106, which is a departure from the designed purpose of the bus 106.

The session component 108 bridges the one or more call processing components 102 across the bus 106 in such a way that is significantly more efficient and allows for dynamic assignment of ports across the multiple cards at the time of receiving or initiating a call. Conventionally, software is written to grab an assigned port for a received call, and use that port until the call is finished. In the system of the invention, the system does not even consider which port to grab until the call starts, grab the first available port, and dynamically grabs more or less ports as the demand increases and decreases. During the session, the system knows which ports are being used, and at the end of the session, releases the ports back into the pool of ports.

In support of call management, the session component 108 can manage a single call across processing resources (e.g., DSP—Digital Signal Processor resources) of at least two of the CPCs (e.g., CPC₁ and CPC₂). Additional features of echo cancellation, noise reduction, volume control, etc., are facilitated by dedicating some of the DSP resources of the CPCs for these purposes. It is within contemplation of the subject invention that other functions can be dedicated to additional DSP resources where suitable code is provided.

The system 100 also includes an access component 110 that facilitates user interaction with features provided in code by the session component 108. The system 100 exposes itself as a network-based API (Application Program Interface) that facilitates processing of general functions, for example, “dial this number”, “play this .wav file on this line”, “bind this line into this conference call”, and “create a new conference call.” In contrast, the session component 108 manages the ports and DSP resources as one large entity of ports and resources.

The session component 108 interfaces to a CTI (Computer Telephony Interface) component 112 that exposes itself as a remote Java™ API to which the access component 110 interfaces. Thus, the graphical user interface provided by a browser interfaces to the CTI component 112, and not to the session component 108 and underlying hardware and software. Note that although the CTI component 112 is shown internal to the system 100, it can be implemented as a separate entity external to the system 100, as hosted on a personal computer, for example.

The bus 106 is a secondary bus that typically handles signals and data, and which are non-voice communications. One example of the communications architecture employed by the bus 106 is an MVIP (Multi-Vendor Integration Protocol) architecture. Another more recent enhancement to the MVIP architecture provides the basis for H.100 bus and H. 110 bus architectures, such as found on a model AG4000C board, and other suitable boards manufactured by NMS Communications, of Framingham, Mass.

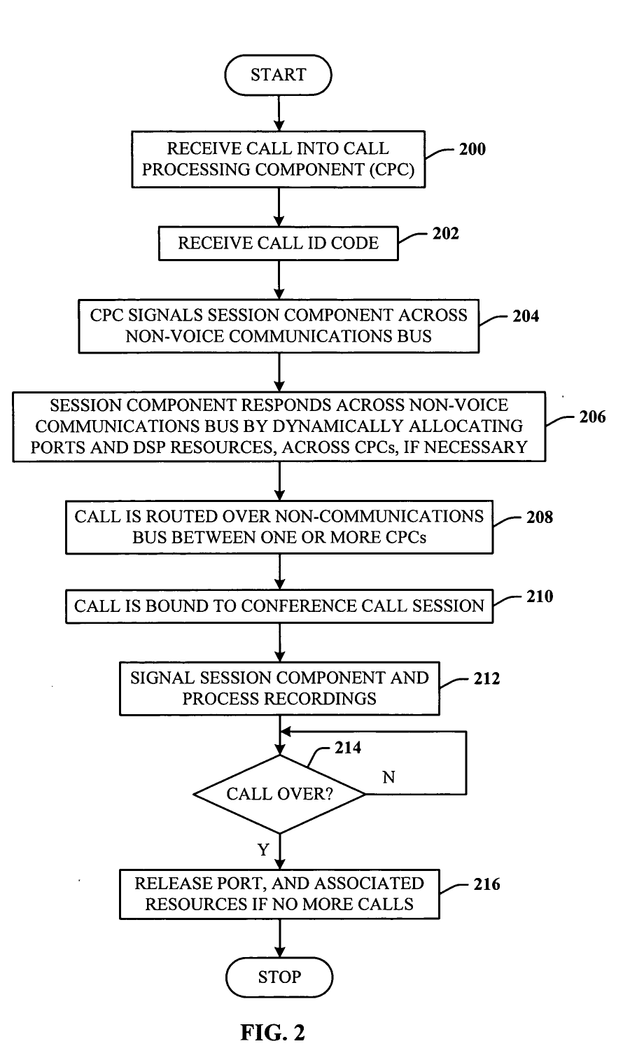

Referring now to FIG. 2, there is illustrated a methodology of call conferencing in accordance with the invention. While, for purposes of simplicity of explanation, the one or more methodologies shown herein, e.g., in the form of a flow chart, are shown and described as a series of acts, it is to be understood and appreciated that the subject invention is not limited by the order of acts, as some acts may, in accordance with the invention, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the invention.

At 200, a call is received at a CPC. The user, in accordance with the invention, also provides an ID, as indicated at 202. This can be a participant IUD that indicates the caller is a participant in a conference call session, or a host ID that indicates the caller will be the host of the conference call. At 204, the CPC that received the call signals the session component across the non-voice communications bus. At 206, the session component responds across the non-voice communications bus by dynamically allocating ports and DSP resources, across CPCs, if necessary. If necessary, at 208, the call is routed over the non-voice communications bus to be processed by the assigned resources on a different CPC than the one that received the call. At 210, the call is bound to a conference call session. At 212, the session component is signaled with respect to one or more recordings that can be played in association with the call. At 214, the system checks if the call is over. If no, flow loops back to keep checking. If yes, at 216, the session component disconnects the call and releases the associated port. If the call is the last of the session, the associated DSP resources will also be released for reassignment to another call session.

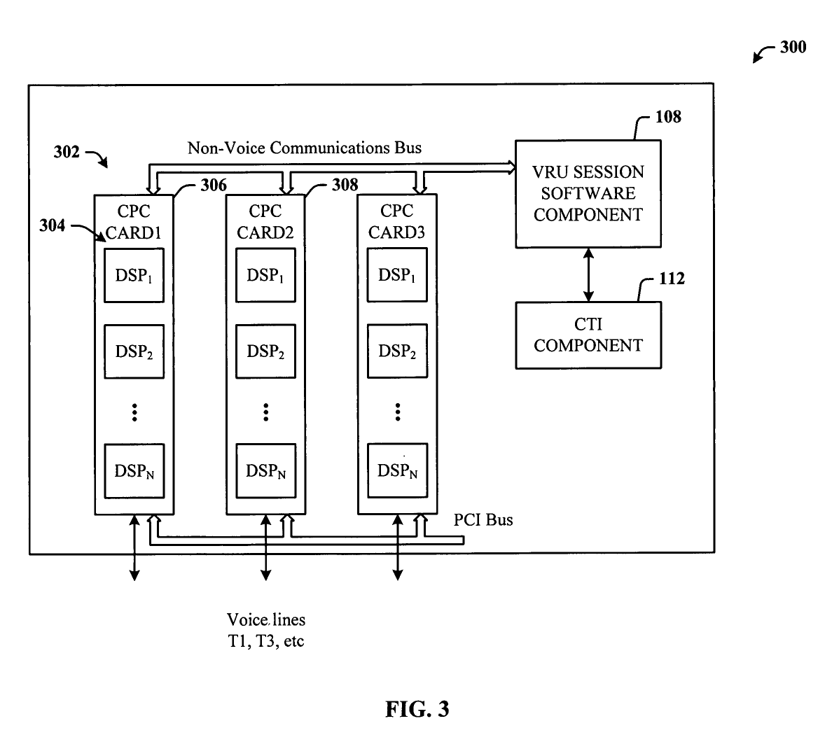

Referring now to FIG. 3, there is illustrated more detailed system diagram of the telephone call processing system 300 of the subject invention. The system 300 (similar to system 100 of FIG. 1) receives incoming calls over voice lines, such as T1 and E1 digital communications connections. A separate line can be provided for each CPC card 302 (denoted here as CPC Card1, CPC Card2, and CPC Card3). Each of the CPC cards 302 includes DSP resources 304 (represented as DSP blocks DSP₁, DSP₂, . . . , DSP_{N}) to which an incoming call is assigned for processing. In accordance with the subject invention, each of the DSP resources 304 is allocated to perform same or different tasks. For example, a first DSP resource (DSP₁) can be allocated for echo cancellation, a second DSP resource (DSP₂) can be allocated for volume control, and a third DSP (not shown) can be allocated for noise reduction, all of which are associated with one or more calls.

The allocation of such DSP resources 304 is accomplished by the session software component 108 (designated as the VRU—voice response unit) which communicates associated commands across the non-voice communications bus to the respective CPC cards 302. Moreover, a call received at a first CPC card 306 can be routed across to a second CPC card 308, via the non-voice communications bus. Thus, the burden of call processing can be scaled to another card. Ultimately, all CPC processing cards and incoming voice lines appear to be one large bound conference calling platform.

The CTI component 112 facilitates interfacing to the system 300 such that high levels commands can be processed and communicated to the session component 108 for execution across the non-voice communications bus 106 to the CPC cards 302.

At a higher level, the many call conferencing benefits and functions can be performed in accordance with the system 300 of the present invention. A user can interface to the system 300 to facilitate a conference call, by initiating contact with prospective participants, binding callers to a specific conference call session, muting, disconnecting, and many other functions in accordance with the subject invention.

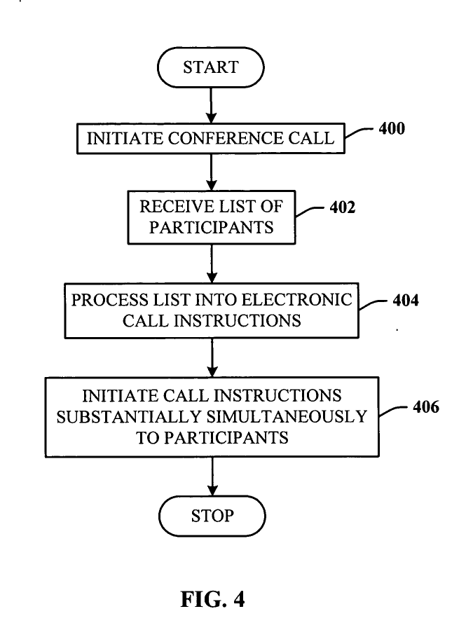

Referring now to FIG. 4, there is illustrated a methodology of performing call conferencing in accordance with the invention. The system is capable of simultaneously dialing several participants at once and binding them to a conference call. Accordingly, at 400, a conference call session is initiated. At 402, a list of participants is received. At 404, the list is processed into electronic call instructions. At 406, the call instructions are processed to initiate calls substantially simultaneously to all participants on the list.

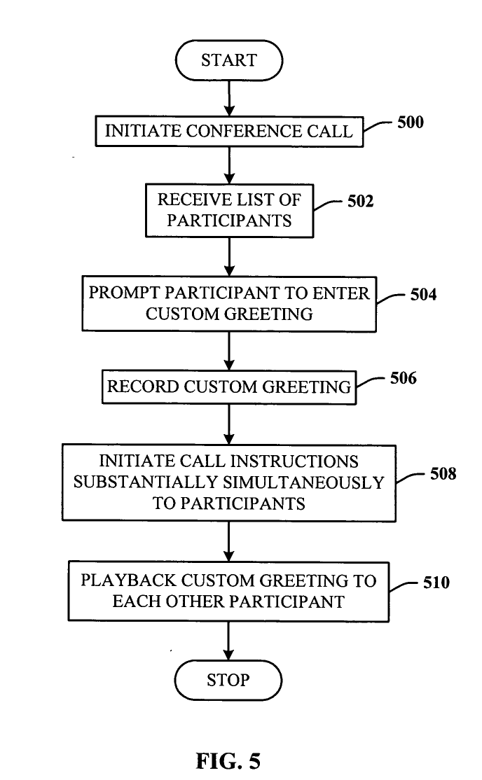

Referring now to FIG. 5, there is illustrated a methodology of processing greetings in accordance with the invention. The software is also capable of calling a conference call host, prompting the host for a custom greeting, recording the custom greeting, and replaying the custom greeting to other participants invited to the conference call. Accordingly, at 500, a conference call session is initiated. At 502, a list of participants is received and processed. At 504, a host is called and prompted to enter a custom greeting. At 506, the custom greeting is input by the host and stored. At 508, call instructions are initiated substantially simultaneously to all participants. At 510, the custom greeting is played back to the session participants who are then logged in to the session.

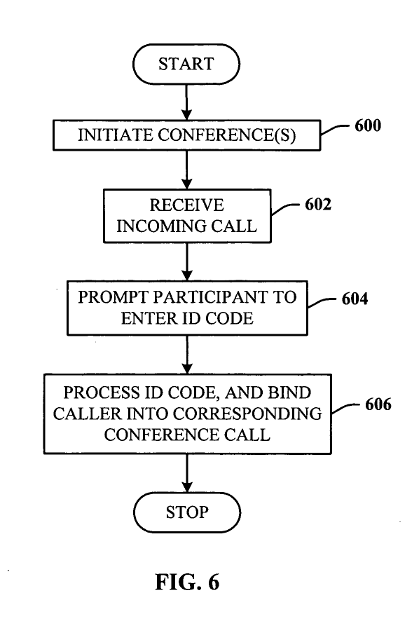

Referring now to FIG. 6, there is illustrated a methodology of connecting a conference participant to the appropriate conference call session in accordance with the invention. At 600, several conference call sessions have been initiated or are in session. At 602, the system receives an incoming call of a session participant. At 604, the system prompts the caller to enter an ID code. At 606, the system processes the ID code, and binds the caller as a participant into the conference call session that corresponds to the ID code.

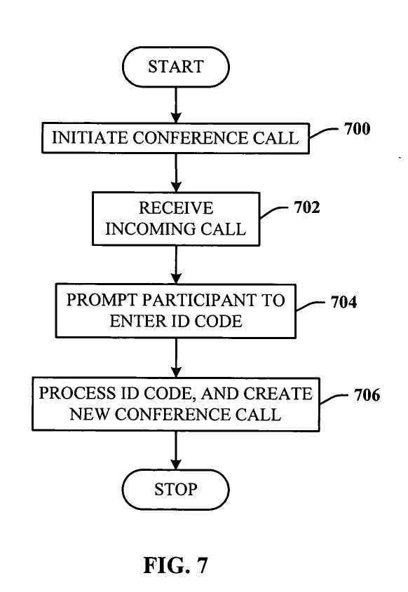

Referring now to FIG. 7, there is illustrated a methodology of creating a new conference call in accordance with the invention. At 700, a conference call is initiated. At 702, an incoming call is received. At 704, the caller is prompted for an ID code. At 706, the ID code is processed, and a new conference call session created.

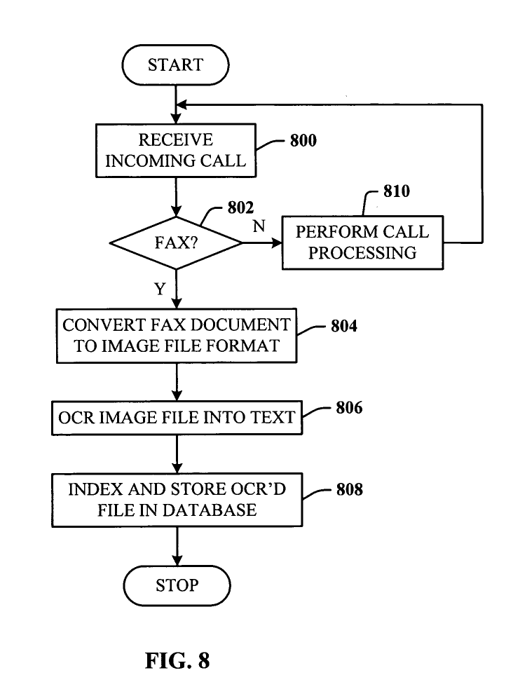

Referring now to FIG. 8, there is illustrated a methodology of processing a received facsimile in accordance with the invention. At 800, the system receives an incoming call, and analyzes the call signals. At 802, if the incoming call is a fax transmission, flow is to 804 to convert the fax document to an image file format, e.g., a TIFF file to a hard drive or other storage device. At 806, the image file is processed by optical character recognition (OCR) into plain text data. At 808, the plain text of the fax can be written to a file for indexing and insertion into a database. At 802, if the call is not a fax, flow is to 810 to process the call normally as a voice call.

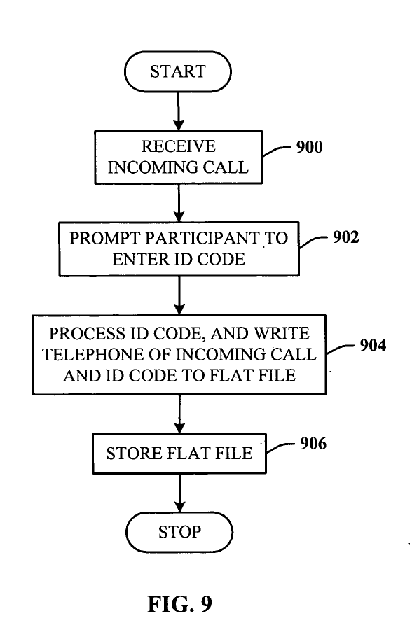

Referring now to FIG. 9, there is illustrated a methodology of capturing incoming information in accordance with the invention. At 900, an incoming call is received. At 902, the caller is prompted to enter an ID code. At 904, the system processes the ID code, and writes the telephone number and ID code of the prospective conference call participant in association therewith to a flat file. At 906, the flat file is then stored for later processing.

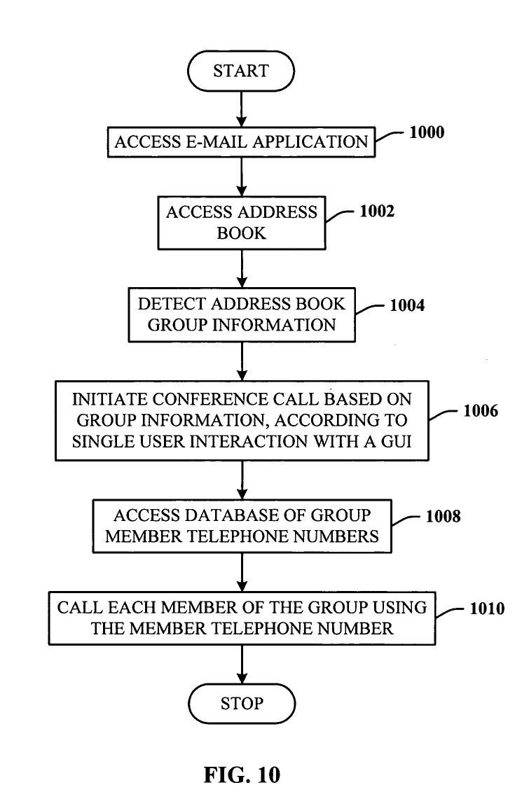

Referring now to FIG. 10, there is illustrated a methodology of processing an e-mail address book in accordance with the invention. A user may establish “groups” from an address book such as that found in Microsoft Outlook™, for example, and the software is capable of allowing the conference manager to invite each member of the group to participate in the conference call via a graphical user interface (GUI) with a single input action (mouse-click). Accordingly, at 1000, an e-mail application is accessed. At 1002, an address book is accessed therefrom. At 1004, group information within the address book is detected. At 1006, a conference call session is initiated based on the group information, and according to a single user click or interaction with the GUI. At 1008, a database of group member telephone numbers is accessed from a database. At 1010, each member of the group is called using the corresponding member telephone number.

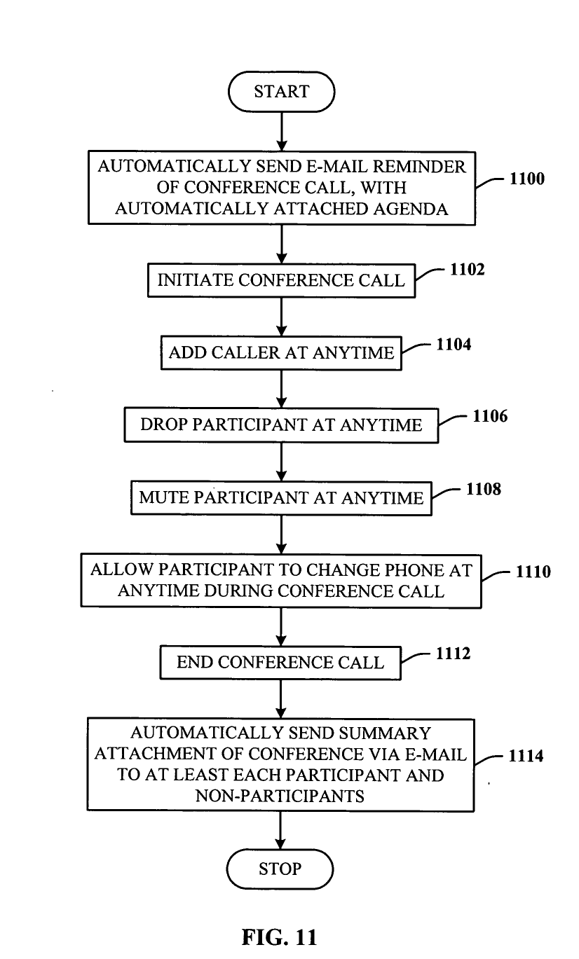

Referring now to FIG. 11, there is illustrated a methodology of managing a conference call session in accordance with the invention. The system of the subject invention permits callers to be added, muted, or dropped at any time, and allows callers to change phones in mid-call. The system can call out to participants simultaneously, eliminating the need to wait for everyone to get online, or can let them call in, adding them at any time. The system can send email reminders with the agenda and minutes automatically prior to calls, during calls, and in written summaries of conference call sessions afterwards. The current capacity of the system enables up to fifty-five participants may be hosted at one time on a conference call with more capacity able to be added within the scope of the invention.

Accordingly, at 1100, the system can automatically send a reminder to each potential session participant via e-mail, and with an automatically attached session agenda and file attachments. At 1102, the conference call session is initiated. At 1104, a caller can be added to the session at anytime. At 1106, a session participant can be dropped from the session at anytime. At 1108, a session participant can be muted at anytime. At 1110, a session participant can be allowed to change telephones at anytime during the session. At 1112, the conference call session ends. At 1114, a session summary can be automatically sent to each participant and/or to any non-participant.

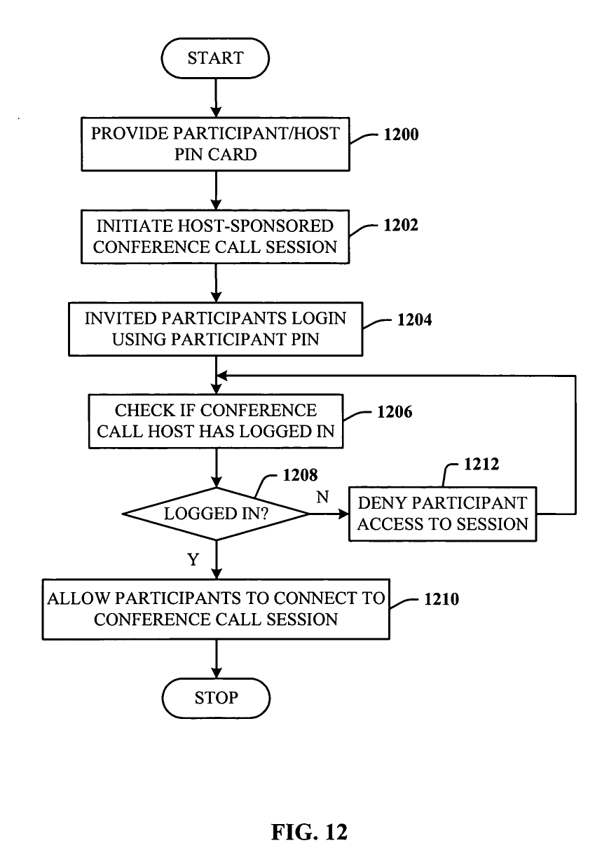

Referring now to FIG. 12, there is illustrated a methodology of managing a session by a host in accordance with the invention. Conference calls may be managed from virtually any computing device and/or telephone, e.g., a touch-tone phone, mobile telephone, personal computer or a wireless PDA (e.g., a Palm™ PDA). More particularly, in keeping with a particularly preferred aspect of the invention, users or participants can dial in using a Personal Identification Number (PN), while the host dials in with another Host PIN that controls when the call starts. In this way, only when the host dials in will the other callers be connected. This is a particularly effective method for a manager or other supervisor to maintain better control over their conference call session. It allows customers the opportunity to issue credit card size conference calling cards containing a permanent Host PIN and Participant PIN to each person who wishes to make conference calls, without ever even having to use a browser interface.

At 1200, a participant/host card is provided with corresponding PINs for each function. At 1202, the caller initiates a host-sponsored conference call session. At 1204, invited participants login using the participant PIN. At 1206, the system determines if the host has logged in to start the session. If so, at 1208, flow is to 1210 to allow callers to check in to the session as participants. Alternatively, if the host has not logged in to start the session, no other participants will be allowed to log in, as indicated by 1212. Flow is then back to 1206 to continue checking for the host login.

The browser interface can be used when more console control is desired over the call, like viewing who is participating in the call and how each participant has been in the session and the how long the session has been in existence. A feature called “Hosted Meet Me” helps prevent potential overuse and misuse of single conferencing PINS. It also prevents the conference call from remaining “open” after the host hangs up. Hosted Meet Me is ideal for large companies that distribute thousands of conferencing PINS to managers, and for university virtual classrooms where the call cannot start until the professor dials in.

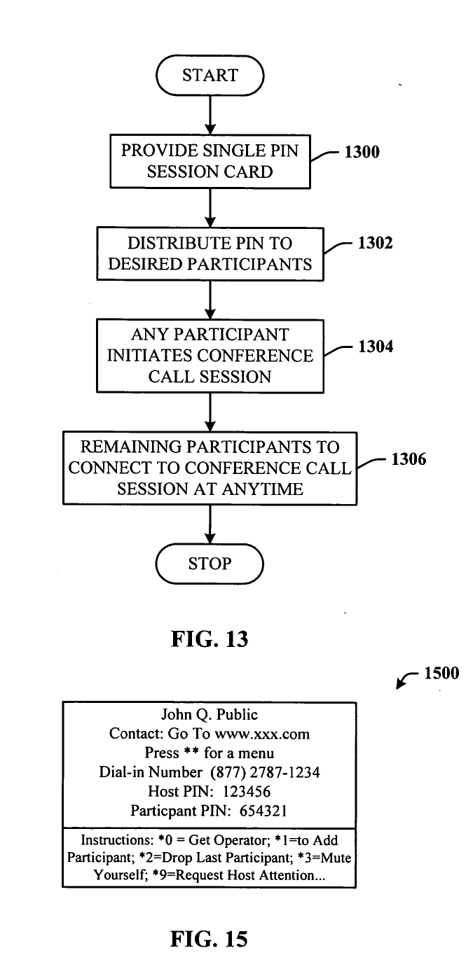

Referring now to FIG. 13, there is illustrated a methodology of managing a conference call session in a no-host manner in accordance with the invention. A single PIN “Meet Me” feature is also provided via the subject invention. This feature issues an active PIN number that can be distributed to any person desired to be in a conference. No Host PIN is created, so whenever any one of these people calls in, a conference call session can begin with any of the other people who received that PIN. This single PIN Meet Me feature is desirable in many situations where a group of people need equal ability for any of them to start a conference call, like among an engineering team.

Accordingly, at 1300, a single PIN session number is provided, in the form of, for example, a card. At 1302, the PIN is distributed to potential conference participants. It is to be appreciated that the PIN can be provided by many other conventional means, for example, e-mail, telephone call, messaging to a messaging device, and so on. At 1304, any person who has the PIN can dial-in to start the conference call session. At 1306, the remaining participants can call to connect to the session at any time.

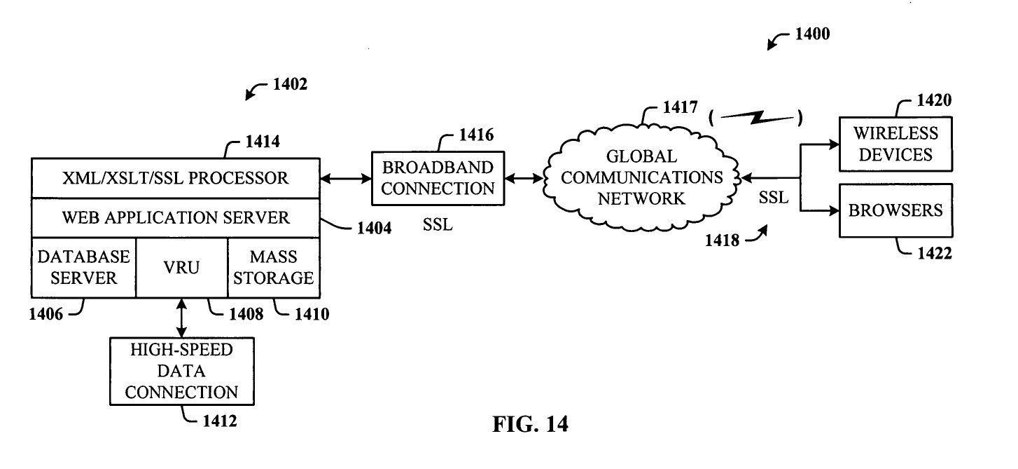

Referring now to FIG. 14, there is illustrated a general system configuration 1400 of the present invention. The system 1400 includes a platform 1402 that hosts at least the data management tool, here called a web application server 1404. The server 1404 provides a common layer to underlying services that include a database server 1406, a VRU (voice response unit) 1408 (also called an interactive VRU or IVRU, and similar to the system 100 of FIG. and system 300 of FIG. 3) and mass storage system 1410. The VRU 1408 facilitates interactive calling features for a user via remote touchtone signals and to voice data to the caller such that the caller can make choices in response to predetermined options presented by the system.

The platform 1402 can utilize at least one multi-channel data communication connection 1412 (e.g., T1, DS3) into the VRU subsystem 1408 for communicating voice information and interacting with features of the platform 1402. As indicated previously, the invention can accommodate user communication from virtually any accessible network node. To facilitate such an interface, the platform 1402 can include a processor 1414 suitable for XML (extensible Markup Language), XSLT (XML Stylesheet Language: Transformations), and SSL processing. The processor 1414 can also access web-based services utilizing SOAP (Simple Object Access Protocol). SOAP employs XML syntax to send text commands across the network using HTTP (HyperText Transport Protocol). Thus, there is a high-speed connection 1416 (e.g., broadband) that interfaces to the processor layer 1414 for use with multiple communication exchanges with remote users disposed on a global communication network 1417. The remote users can access the platform system 1402 via a SSL connection 1418 using portable wired/wireless devices 1420, and by way of the associated browsers 1422.

FIG. 15 illustrates a sample PIN card 1500 that can be used to access a conference call in accordance with the invention. The card 1500 includes access information in the format of a URL address that can be used to enter into a conference call as a participant (using the participant PIN) or the host (using the host PIN). Other selections allow the caller to get an operator, access an options menu, add a participant, increase volume, drop the last participant, record a session, mute yourself, decrease volume, and unmute/request host attention.

Following is sample code communications between the CTI 112 and the session component 108 of FIG. 1, which together can be considered the VRU 1408 of FIG. 14. The code illustrates a typical dial in, enter pin number, put oneself on mute, and adding a participant using *1. Both people then hang up.

This first section involves the VRU detecting and receiving an incoming call, and then sending a message to a SCP (Service Control Point). SCP is an SS7 (Signal System 7) signaling point containing a centralized database or enhanced service application. SS7 is an out-of-band signaling system that provides fast call setup (using circuit-switched connections) and transaction capabilities for remote database interactions. For example, toll-free number translation databases, or a HLR (home location register) and a VLR (visitor location register) databases in wireless networks. Once the user has input a PIN code, the SCP is contacted.

| | |
|---|---|
| \|022\|10/28 15:48:12 | \| [Event: NCCEVN_SEIZURE_DETECTED] |
| \|022\|10/28 15:48:12 | \| Change line 22 status to [Z] Seized from [R] |
| \|022\|10/28 15:48:12 | \| |
| \|022\|10/28 15:48:12 | \| ***** New Call ***** |
| \|022\|10/28 15:48:12 | \| |
| \|022\|10/28 15:48:12 | \| [Event: NCCEVN_INCOMING_CALL] |
| \|022\|10/28 15:48:12 | \| Change line 22 status to [I] Incoming from [Z] |
| \|022\|10/28 15:48:12 | \| Called [9054] |
| \|022\|10/28 15:48:12 | \| Calling [xxx8180284] |
| \|022\|10/28 15:48:12 | \| InfoDig [−1] |
| \|022\|10/28 15:48:12 | \| Send packet to SCP 127.0.0.1:6001 Type =Y |
| \|022\|10/28 15:48:12 | \| +------VRU->SCP-------- |
| \| PacketID: | [1] |
| \| TrxID: | [0] |
| \| Result: | [3] |
| \| Detail: | [0] |
| \| Data: | [ ] |
| \| Called: | [9054] |
| \| Calling: | [xxx8180284] |
| \| Port: | [22] |
| \| Attempts: | [0] |
| \| Status1: | [0] |
| \| Status2: | [0] |

+----------------------

| | |
|---|---|
| \|022\|10/28 15:48:12 | \| Received answer from SCP |
| \|022\|10/28 15:48:12 | \| +------Packet from SCP-------- |
| \| TrxID | [99000000] |
| \| MsgNum | [310] |
| \| AnsType | [D] |
| \| Action | [A] |
| \| MinLen | [6] |
| \| MaxLen | [6] |
| \| Beep | [0] |
| \| Flush | [Y] |
| \| Interrupt | [Y] |
| \| TO1 | [8000] |
| \| TO2 | [3000] |
| \| Retries | [1] |
| \| Term | [#] |
| \| Erase | [*] |
| \| Special | [0] |
| \| Dnis | [ ] |
| \| Ani | [ ] |
| \| Data | [ ] |

+------Packet from SCP--------

| | |
|---|---|
| \|022\|10/28 15:48:12 | \| [Unknown CTA Event: *** (20002003) v = 00000000] |
| \|022\|10/28 15:48:12 | \| CurrentStep: [0] [1] |
| \|022\|10/28 15:48:12 | \| Answer the call |
| \|022\|10/28 15:48:12 | \| [Event: NCCEVN_ANSWERING_CALL] |
| \|022\|10/28 15:48:12 | \| [Event: NCCEVN_CALL_CONNECTED, NCC_CON_ANSWERED] |
| \|022\|10/28 15:48:12 | \| [Unknown CTA Event: *** (20002003) v = 00000000] |
| \|022\|10/28 15:48:12 | \| CurrentStep: [1] [4] |
| \|022\|10/28 15:48:12 | \| Flushing TouchTone Buffer |
| \|022\|10/28 15:48:12 | \| Playing [/opt/1h/msgs/00000310.wav] |
| \|022\|10/28 15:48:13 | \| [Event: ADIEVN_DIGIT_BEGIN, ‘3’] |
| \|022\|10/28 15:48:13 | \| [Event: VCEEVN_PLAY_DONE, Digit , msec=1480] |
| \|022\|10/28 15:48:13 | \| [Unknown CTA Event: *** (20002003) v = 00000000] |
| \|022\|10/28 15:48:13 | \| CurrentStep: [2] [5] |
| \|022\|10/28 15:48:13 | \| Collect [6] DTMFs |
| \|022\|10/28 15:48:13 | \| [Event: ADIEVN_DIGIT_END] |
| \|022\|10/28 15:48:14 | \| [Event: ADIEVN_DIGIT_BEGIN, ‘9’] |
| \|022\|10/28 15:48:14 | \| [Event: ADIEVN_DIGIT_END] |
| \|022\|10/28 15:48:14 | \| [Event: ADIEVN_DIGIT_BEGIN, ‘6’] |
| \|022\|10/28 15:48:14 | \| [Event: ADIEVN_DIGIT_END] |
| \|022\|10/28 15:48:15 | \| [Event: ADIEVN_DIGIT_BEGIN, ‘6’] |
| \|022\|10/28 15:48:15 | \| [Event: ADIEVN_DIGIT_END] |
| \|022\|10/28 15:48:15 | \| [Event: ADIEVN_DIGIT_BEGIN, ‘7’] |
| \|022\|10/28 15:48:15 | \| [Event: ADIEVN_DIGIT_END] |
| \|022\|10/28 15:48:15 | \| [Event: ADIEVN_DIGIT_BEGIN, ‘2’] |
| \|022\|10/28 15:48:16 | \| [Event: ADIEVN_DIGIT_END] |
| \|022\|10/28 15:48:16 | \| [Event: ADIEVN_COLLECTION_DONE, Finished |
| | digit string = ‘396672’] |
| \|022\|10/28 15:48:16 | \| [Unknown CTA Event: *** (20002003) v = 00000000] |
| \|022\|10/28 15:48:16 | \| CurrentStep: [3] [−1] |
| \|022\|10/28 15:48:16 | \| Send packet to SCP 127.0.0.1:6001 Type =Y |
| \|022\|10/28 15:48:16 | \| +------VRU->SCP-------- |
| \| PacketID: | [1] |
| \| TrxID: | [99000000] |
| \| Result: | [1] |
| \| Detail: | [1] |
| \| Data: | [396672] |
| \| Called: | [9054] |
| \| Calling: | [xxx8180284] |
| \| Port: | [22] |
| \| Attempts: | [1] |
| \| Status1: | [1] |
| \| Status2: | [30] |

+----------------------

Next, the PIN code is validated using the SCP, and the connection is accepted. A conference call session is created. A voice file is played, and a participant is added to the conference call session. DSP resources are also managed to allocated ports for the calls.

| | |
|---|---|
| \|702\|10/28 15:48:19 | \| Accept a connection |
| \|702\|10/28 15:48:19 | \| [006] Start CONNECTION thread |
| \|702\|10/28 15:48:19 | \| +------SCP->VRU-------- |
| \| TrxID: | [70] |
| \| Command: | [4] |
| \| Data: | [5] |

+----------------------

| | |
|---|---|
| \|704\|10/28 15:48:19 | \| ATTEMPT->Create Conf [TRXID,CCID,Index] [70:70:2] |
| \|704\|10/28 15:48:19 | \| [Unknown CTA Event: *** (20002005) v = 00000000] |
| \|704\|10/28 15:48:19 | \| Resource |
| | [Number:Board:CAPS:#CONFS:MAX_MEM:AV_MEM] |
| | [0:0:124:0:64:64] |
| \|704\|10/28 15:48:19 | \| SUCCESS->Create Conf[CCID:INDEX:]{70:2] |
| \|702\|10/28 15:48:19 | \| +------VRU->SCP-------- |
| \| TrxID: | [70] |
| \| Result: | [1] |
| \| ErrorCode: | [0] |
| \| Data: | [1024] |

+----------------------

| | |
|---|---|
| \|702\|10/28 15:48:19 | \| [006] Closing connection |
| \|702\|10/28 15:48:19 | \| [006] Terminate CONNECTION thread |
| \|022\|10/28 15:48:20 | \| Received answer from SCP |
| \|022\|10/28 15:48:20 | \| +------Packet from SCP-------- |
| \| TrxID | [70] |
| \| MsgNum | [301] |
| \| AnsType | [N] |
| \| Action | [P] |
| \| MinLen | [0] |
| \| MaxLen | [0] |
| \| Beep | [1] |
| \| Flush | [Y] |
| \| Interrupt | [N] |
| \| TO1 | [8000] |
| \| TO2 | [3000] |
| \| Retries | [1] |
| \| Term | [#] |
| \| Erase | [*] |
| \| Special | [3] |
| \| Dnis | [ ] |
| \| Ani | [ ] |
| \| Data | [ ] |

+------Packet from SCP--------

| | |
|---|---|
| \|022\|10/28 15:48:20 | \| [Unknown CTA Event: *** (20002003) v = 00000000] |
| \|022\|10/28 15:48:20 | \| CurrentStep: [0] [4] |
| \|022\|10/28 15:48:20 | \| Flushing TouchTone Buffer |
| \|022\|10/28 15:48:20 | \| Playing [/opt/1h/msgs/00000301.wav] |
| \|022\|10/28 15:48:27 | \| [Event: VCEEVN_PLAY_DONE, Finished , msec=7070] |
| \|022\|10/28 15:48:27 | \| [Unknown CTA Event: *** (20002003) v = 00000000] |
| \|022\|10/28 15:48:27 | \| CurrentStep: [1] [10] |
| \|022\|10/28 15:48:27 | \| trying to get info for conf[2], ccid[70] |
| | member [0] |
| \|704\|10/28 15:48:27 | \| GetConfInfo( ) -> |
| | Allocated[5],Joined[0],flags [0],capabilities[124].user_data[0] |
| \|022\|10/28 15:48:27 | \| AddMember( )->Member [0] added to conference[2] |
| | totalmembers[1] port[22] |
| \|704\|10/28 15:48:27 | \| AddMember( )->Member [0] added to conference [2] |
| | totalmembers[1] port[22] |
| \|022\|10/28 15:48:27 | \| SwitchMember Disconnect Port [22:0:1:22] from DSP |
| | [0:16:22] |
| \|705\|10/28 15:48:27 | \| SwitchMember Disconnect Port [22:0:1:22] from DSP |
| | [0:16:22] |
| \|022\|10/28 15:48:27 | \| SwitchMember Connect Port [22:0:0:22] to Member |
| | [0:0:33:0] \|705\|10/28 15:48:27 \| SwitchMember Connect Port [22:0:0:22] |
| | to Member [0:0:33:0] \|704\|10/28 15:48:27 \| AddMember( ) ->ETD_EN[0:1:1] |
| | AGC_IO[0:0] GAIN_IO[2:0] |
| \|022\|10/28 15:48:27 | \| AddMember( ) ->ETD_EN[0:1:1] AGC_IO[0:0] |
| | \|022\|GAIN_IO[2:0] |
| \|022\|10/28 15:48:27 | \| AddMember( )->Tone[1] Success. CONF->[2] |
| \|704\|10/28 15:48:27 | \| AddMember( )->Tone[1] Success. CONF->[2] |
| \|022\|10/28 15:48:27 | \| Change line 22 status to [C] Conferenced from [I] |
| \|022\|10/28 15:48:27 | \| [Unknown CTA Event: *** (20002003) v = 00000000] |
| \|022\|10/28 15:48:27 | \| CurrentStep: [2] [−1] |
| \|022\|10/28 15:48:27 | \| Send packet to SCP 127.0.0.1:6001 Type =Y |
| \|022\|10/28 15:48:27 | \| +------VRU->SCP-------- |
| \| PacketID: | [1] |
| \| TrxID: | [70] |
| \| Result: | [1] |
| \| Detail: | [0] |
| \| Data: | [ ] |
| \| Called: | [9054] |
| \| Calling: | [xxx8180284] |
| \| Port: | [22] |
| \| Attempts: | [0] |
| \| Status1: | [2] |
| \| Status2: | [0] |

+----------------------

| | |
|---|---|
| \|022\|10/28 15:48:27 | \| Received answer from SCP |
| \|022\|10/28 15:48:27 | \| +------Packet from SCP-------- |
| \| TrxID | [70] |
| \| MsgNum | [0] |
| \| AnsType | [D] |
| \| Action | [N] |
| \| MinLen | [2] |
| \| MaxLen | [2] |
| \| Beep | [0] |
| \| Flush | [Y] |
| \| Interrupt | [Y] |
| \| TO1 | [0] |
| \| TO2 | [3000] |
| \| Retries | [1] |
| \| Term | [#] |
| \| Erase | [A] |
| \| Special | [0] |
| \| Dnis | [ ] |
| \| Ani | [ ] |
| \| Data | [ ] |

+------Packet from SCP--------

Next, DTMF (Dual-Tone Multi-Frequency) signals are received and processed through to the SCP.

| | |
|---|---|
| \|022\|10/28 15:48:27 | \| [Unknown CTA Event: *** (20002003) v = 00000000] |
| \|022\|10/28 15:48:27 | \| CurrentStep: [0] [5] |
| \|022\|10/28 15:48:27 | \| Collect [2] DTMFs |
| \|022\|10/28 15:48:28 | \| [Event: ADIEVN_DIGIT_BEGIN, ‘*’] |
| \|022\|10/28 15:48:28 | \| [Event: ADIEVN_DIGIT_END] |
| \|022\|10/28 15:48:28 | \| [Event: ADIEVN_DIGIT_BEGIN, ‘7’] |
| \|022\|10/28 15:48:28 | \| [Event: ADIEVN_DIGIT_END] |
| \|022\|10/28 15:48:28 | \| [Event: ADIEVN_COLLECTION_DONE, Finished |
| | digit string = ‘*7’] |
| \|022\|10/28 15:48:28 | \| [Unknown CTA Event: *** (20002003) v = 00000000] |
| \|022\|10/28 15:48:28 | \| CurrentStep: [1] [−1] |
| \|022\|10/28 15:48:28 | \| Send packet to SCP 127.0.0.1:6001 Type =Y |
| \|022\|10/28 15:48:28 | \| +------VRU->SCP-------- |
| \| PacketID: | [1] |
| \| TrxID: | [70] |
| \| Result: | [1] |
| \| Detail: | [0] |
| \| Data: | [*7] |
| \| Called: | [9054] |
| \| Calling: | [6148180284] |
| \| Port: | [22] |
| \| Attempts: | [1] |
| \| Status1: | [3] |
| \| Status2: | [0] |

+----------------------

| | |
|---|---|
| \|022\|10/28 15:48:28 | \| Received answer from SCP |
| \|022\|10/28 15:48:28 | \| +------Packet from SCP-------- |
| \| TrxID | [70] |
| \| MsgNum | [402] |
| \| AnsType | [M] |
| \| Action | [N] |
| \| MinLen | [2] |
| \| MaxLen | [2] |
| \| Beep | [0] |
| \| Flush | [Y] |
| \| Interrupt | [Y] |
| \| TO1 | [0] |
| \| TO2 | [3000] |
| \| Retries | [1] |
| \| Term | [#] |
| \| Erase | [A] |
| \| Special | [0] |
| \| Dnis | [ ] |
| \| Ani | [ ] |
| \| Data | [ ] |

+------Packet from SCP--------

Here, DSP resources are managed for port allocation, a participant is added to the session, the host is muted, and a voice file played.

| | |
|---|---|
| \|022\|10/28 15:48:28 | \| [Unknown CTA Event: *** (20002003) v = 00000000] |
| \|022\|10/28 15:48:28 | \| CurrentStep: [0] [27] |
| \|022\|10/28 15:48:28 | \| SwitchMember DisConnect Port [22:0:0:22] from |
| | Member [0:0:33:0] |
| \|705\|10/28 15:48:28 | \| SwitchMember DisConnect Port [22:0:0:22] from |
| | Member [0:0:33:0] |
| \|022\|10/28 15:48:28 | \| SwitchMember Connect Port [22:0:1:22] to DSP |
| | \|022\|[0:16:22] |
| \|705\|10/28 15:48:28 | \| SwitchMember Connect Port [22:0:1:22] to DSP |
| | [0:16:22] |
| \|022\|10/28 15:48:28 | \| [Unknown CTA Event: *** (20002003) v = 00000000] |
| \|022\|10/28 15:48:28 | \| CurrentStep: [1] [4] |
| \|022\|10/28 15:48:28 | \| Flushing TouchTone Buffer |
| \|022\|10/28 15:48:28 | \| Playing [/opt/lh/msgs/00000402.wav] |
| \|022\|10/28 15:48:29 | \| [Event: VCEEVN_PLAY_DONE, Finished, msec=1010] |
| \|022\|10/28 15:48:29 | \| [Unknown CTA Event: *** (20002003) v = 00000000] |
| \|022\|10/28 15:48:29 | \| CurrentStep: [2] [26] |
| \|022\|10/28 15:48:29 | \| SwitchMember Disconnect Port [22:0:1:22] from DSP |
| | [0:16:22] |
| \|705\|10/28 15:48:29 | \| SwitchMember Disconnect Port [22:0:1:22] from DSP |
| | [0:16:22] |
| \|022\|10/28 15:48:29 | \| SwitchMember Connect Port [22:0:0:22] to Member |
| | [0:0:33:0] \|705\|10/28 15:48:29 \| SwitchMember Connect Port [22:0:0:22] |
| | to Member [0:0:33:0]\|022\|10/28 15:48:29 \| [Unknown CTA Event: *** |
| | (20002003) v = 00000000] |
| \|022\|10/28 15:48:29 | \| CurrentStep: [3] [14] |
| \|022\|10/28 15:48:29 | \| TalkEnable( )->Talker Disabled. CONF->[2] |
| \|704\|10/28 15:48:29 | \| AddMember( )->Talker Disabled. CONF->[2] |
| \|022\|10/28 15:48:29 | \| [Unknown CTA Event: *** (20002003) v = 00000000] |
| \|022\|10/28 15:48:29 | \| CurrentStep: [4] [5] |
| \|022\|10/28 15:48:29 | \| Collect [2] DTMFs |
| \|022\|10/28 15:48:34 | \| [Event: ADIEVN_DIGIT_BEGIN, ‘*’] |
| \|022\|10/28 15:48:34 | \| [Event: ADIEVN_DIGIT_END] |
| \|022\|10/28 15:48:35 | \| [Event: ADIEVN_DIGIT_BEGIN, ‘1’] |
| \|022\|10/28 15:48:35 | \| [Event: ADIEVN_DIGIT_END] |
| \|022\|10/28 15:48:35 | \| [Event: ADIEVN_COLLECTION_DONE, Finished |
| | digit string = ‘*1’] |
| \|022\|10/28 15:48:35 | \| [Unknown CTA Event: *** (20002003) v = 00000000] |
| \|022\|10/28 15:48:35 | \| CurrentStep: [5] [−1] |
| \|022\|10/28 15:48:35 | \| Send packet to SCP 127.0.0.1:6001 Type =Y |
| \|022\|10/28 15:48:35 | \| +------VRU->SCP-------- |
| \| PacketID: | [1] |
| \| TrxID: | [70] |
| \| Result: | [1] |
| \| Detail: | [0] |
| \| Data: | [*1] |
| \| Called: | [9054] |
| \| Calling: | [xxx8180284] |
| \| Port: | [22] |
| \| Attempts: | [1] |
| \| Status1: | [4] |
| \| Status2: | [0] |

+----------------------

| | |
|---|---|
| \|022\|10/28 15:48:35 | \| Received answer from SCP |
| \|022\|10/28 15:48:35 | \| +------Packet from SCP-------- |
| \| TrxID | [70] |
| \| MsgNum | [407] |
| \| AnsType | [D] |
| \| Action | [N] |
| \| MinLen | [10] |
| \| MaxLen | [10] |
| \| Beep | [0] |
| \| Flush | [N] |
| \| Interrupt | [Y] |
| \| TO1 | [30000] |
| \| TO2 | [4000] |
| \| Retries | [1] |
| \| Term | [#] |
| \| Erase | [*] |
| \| Special | [0] |
| \| Dnis | [ ] |
| \| Ani | [ ] |
| \| Data | [ ] |

+------Packet from SCP--------

Here, the conference call session is configured by the session host.

| | |
|---|---|
| \|022\|10/28 15:48:35 | \| [Unknown CTA Event: *** (20002003) v = 00000000] |
| \|022\|10/28 15:48:35 | \| CurrentStep: [0] [27] |
| \|022\|10/28 15:48:35 | \| SwitchMember DisConnect Port [22:0:0:22] from |
| | Member [0:0:33:0] |
| \|705\|10/28 15:48:35 | \| SwitchMember DisConnect Port [22:0:0:22] from |
| | Member [0:0:33:0] |
| \|022\|10/28 15:48:35 | \| SwitchMember Connect Port [22:0:1:22] to DSP |
| | \|022\|[0:16:22] |
| \|705\|10/28 15:48:35 | \| SwitchMember Connect Port [22:0:1:22] to DSP |
| | [0:16:22] |
| \|022\|10/28 15:48:35 | \| [Unknown CTA Event: *** (20002003) v = 00000000] |
| \|022\|10/28 15:48:35 | \| CurrentStep: [1] [4] |
| \|022\|10/28 15:48:35 | \| Playing [/opt/lh/msgs/00000407.wav] |
| \|022\|10/28 15:48:37 | \| [Event: VCEEVN_PLAY_DONE, Finished , msec=1900] |
| \|022\|10/28 15:48:37 | \| [Unknown CTA Event: *** (20002003) v = 00000000] |
| \|022\|10/28 15:48:37 | \| CurrentStep: [2] [26] |
| \|022\|10/28 15:48:37 | \| SwitchMember Disconnect Port [22:0:1:22] from DSP |
| | [0:16:22] |
| \|705\|10/28 15:48:37 | \| SwitchMember Disconnect Port [22:0:1:22] from DSP |
| | [0:16:22] |
| \|022\|10/28 15:48:37 | \| SwitchMember Connect Port [22:0:0:22] to Member |
| | [0:0:33:0] \|705\|10/28 15:48:37 \| SwitchMember Connect Port [22:0:0:22] |
| | to Member [0:0:33:0] \|022\|10/28 15:48:37 \| [Unknown CTA Event: *** |
| | (20002003) v = 00000000] |
| \|022\|10/28 15:48:37 | \| CurrentStep: [3] [5] |
| \|022\|10/28 15:48:37 | \| Collect [10] DTMFs |
| \|022\|10/28 15:48:39 | \| [Event: ADIEVN_DIGIT_BEGIN, ‘x’] |
| \|022\|10/28 15:48:39 | \| [Event: ADIEVN_DIGIT_END] |
| \|022\|10/28 15:48:39 | \| [Event: ADIEVN_DIGIT_BEGIN, ‘x’] |
| \|022\|10/28 15:48:39 | \| [Event: ADIEVN_DIGIT_END] |
| \|022\|10/28 15:48:39 | \| [Event: ADIEVN_DIGIT_BEGIN, ‘x’] |
| \|022\|10/28 15:48:39 | \| [Event: ADIEVN_DIGIT_END] |
| \|022\|10/28 15:48:39 | \| [Event: ADIEVN_DIGIT_BEGIN, ‘6’] |
| \|022\|10/28 15:48:39 | \| [Event: ADIEVN_DIGIT_END] |
| \|022\|10/28 15:48:40 | \| [Event: ADIEVN_DIGIT_BEGIN, ‘0’] |
| \|022\|10/28 15:48:40 | \| [Event: ADIEVN_DIGIT_END] |
| \|022\|10/28 15:48:40 | \| [Event: ADIEVN_DIGIT_BEGIN, ‘7’] |
| \|022\|10/28 15:48:40 | \| [Event: ADIEVN_DIGIT_END] |
| \|022\|10/28 15:48:41 | \| [Event: ADIEVN_DIGIT_BEGIN, ‘0’] |
| \|022\|10/28 15:48:41 | \| [Event: ADIEVN_DIGIT_END] |
| \|022\|10/28 15:48:41 | \| [Event: ADIEVN_DIGIT_BEGIN, ‘2’] |
| \|022\|10/28 15:48:41 | \| [Event: ADIEVN_DIGIT_END] |
| \|022\|10/28 15:48:41 | \| [Event: ADIEVN_DIGIT_BEGIN, ‘3’] |
| \|022\|10/28 15:48:41 | \| [Event: ADIEVN_DIGIT_END] |
| \|022\|10/28 15:48:42 | \| [Event: ADIEVN_DIGIT_BEGIN, ‘7’] |
| \|022\|10/28 15:48:42 | \| [Event: ADIEVN_DIGIT_END] |
| \|022\|10/28 15:48:42 | \| [Event: ADIEVN_COLLECTION_DONE, Finished |
| | digit string = ‘xxx6070237’] |
| \|022\|10/28 15:48:42 | \| [Unknown CTA Event: *** (20002003) v = 00000000] |
| \|022\|10/28 15:48:42 | \| CurrentStep: [4] [−1] |
| \|022\|10/28 15:48:42 | \| Send packet to SCP 127.0.0.1:6001 Type =Y |
| \|022\|10/28 15:48:42 | \| +------VRU->SCP-------- |
| \| PacketID: | [1] |
| \| TrxID: | [70] |
| \| Result: | [1] |
| \| Detail: | [0] |
| \| Data: | [6146070237] |
| \| Called: | [9054] |
| \| Calling: | [6148180284] |
| \| Port: | [22] |
| \| Attempts: | [1] |
| \| Status1: | [5] |
| \| Status2: | [0] |

+----------------------

| | |
|---|---|
| \|702\|10/28 15:48:42 | \| Accept a connection |
| \|702\|10/28 15:48:42 | \| [012] Start CONNECTION thread |
| \|702\|10/28 15:48:42 | \| +------SCP->VRU-------- |
| \| TrxID: | [70] |
| \| Command: | [1] |
| \| Data: | [1] |

+----------------------

| | |
|---|---|
| \|702\|10/28 15:48:42 | \| Reserve Lines [70] [1] |
| \|000\|10/28 15:48:42 | \| Change line 0 status to [Y] from [R] |
| \|702\|10/28 15:48:42 | \| Server IP address for Port [0]: [127.0.0.1] [6001] |
| \|702\|10/28 15:48:42 | \| +------VRU->SCP-------- |
| \| TrxID: | [70] |
| \| Result: | [1] |
| \| ErrorCode: | [0] |
| \| Data: | [0] |

+----------------------

| | |
|---|---|
| \|000\|10/28 15:48:42 | \| Change line 0 status to [&] from [Y] |
| \|000\|10/28 15:48:42 | \| [Unknown CTA Event: *** (20002004) v = 00000000] |
| \|000\|10/28 15:48:42 | \| Send packet to SCP 127.0.0.1:6001 Type =Y |
| \|000\|10/28 15:48:42 | \| +------VRU->SCP-------- |
| \| PacketID: | [1] |
| \| TrxID: | [70] |
| \| Result: | [3] |
| \| Detail: | [0] |
| \| Data: | [ ] |
| \| Called: | [ ] |
| \| Calling: | [ ] |
| \| Port: | [0] |
| \| Attempts: | [0] |
| \| Status1: | [0] |
| \| Status2: | [0] |

+----------------------

| | |
|---|---|
| \|702\|10/28 15:48:42 | \| [012] Closing connection |
| \|702\|10/28 15:48:42 | \| [012] Terminate CONNECTION thread |
| \|022\|10/28 15:48:42 | \| Received answer from SCP |
| \|022\|10/28 15:48:42 | \| +------Packet from SCP-------- |
| \| TrxID | [70] |
| \| MsgNum | [409] |
| \| AnsType | [D] |
| \| Action | [N] |
| \| MinLen | [2] |
| \| MaxLen | [2] |
| \| Beep | [0] |
| \| Flush | [Y] |
| \| Interrupt | [Y] |
| \| TO1 | [0] |
| \| TO2 | [3000] |
| \| Retries | [1] |
| \| Term | [#] |
| \| Erase | [A] |
| \| Special | [0] |
| \| Dnis | [ ] |
| \| Ani | [ ] |
| \| Data | [ ] |

+------Packet from SCP--------

| | |
|---|---|
| \|022\|10/28 15:48:42 | \| [Unknown CTA Event: *** (20002003) v = 00000000] |
| \|022\|10/28 15:48:42 | \| CurrentStep: [0] [27] |
| \|000\|10/28 15:48:42 | \| Received answer from SCP |
| \|000\|10/28 15:48:42 | \| +------Packet from SCP-------- |
| \| TrxID | [70] |
| \| MsgNum | [0] |
| \| AnsType | [N] |
| \| Action | [D] |
| \| MinLen | [0] |
| \| MaxLen | [0] |
| \| Beep | [0] |
| \| Flush | [Y] |
| \| Interrupt | [Y] |
| \| TO1 | [8000] |
| \| TO2 | [3000] |
| \| Retries | [1] |
| \| Term | [#] |
| \| Erase | [*] |
| \| Special | [0] |
| \| Dnis | [6146070237] |
| \| Ani | [8772229054] |
| \| Data | [R7\|B4\|F\|C258\|D64] |

+------Packet from SCP--------

Here, a session participant is called in preparation for entry into the conference call session.

| | |
|---|---|
| \|000\|10/28 15:48:42 | \| [Unknown CTA Event: *** (20002003) v = 00000000] |
| \|000\|10/28 15:48:42 | \| CurrentStep: [0] [8] |
| \|000\|10/28 15:48:42 | \| Change line 0 status to [D] Dialing from [M] |
| \|022\|10/28 15:48:42 | \| SwitchMember DisConnect Port [22:0:0:22] from |
| | Member [0:0:33:0] |
| \|705\|10/28 15:48:42 | \| SwitchMember DisConnect Port [22:0:0:22] from |
| | Member [0:0:33:0] |
| \|022\|10/28 15:48:42 | \| SwitchMember Connect Port [22:0:1:22] to DSP |
| | \|022\|[0:16:22] |
| \|705\|10/28 15:48:42 | \| SwitchMember Connect Port [22:0:1:22] to DSP |
| | [0:16:22] |
| \|022\|10/28 15:48:42 | \| [Unknown CTA Event: *** (20002003) v = 00000000] |
| \|000\|10/28 15:48:42 | \| Dialing a Number [xxx6070237] |
| \|022\|10/28 15:48:42 | \| CurrentStep: [1] [4] |
| \|000\|10/28 15:48:42 | \| Called size => [8] |
| \|022\|10/28 15:48:42 | \| Flushing TouchTone Buffer |
| \|000\|10/28 15:48:42 | \| Called type => [2] |
| \|000\|10/28 15:48:42 | \| Called plan => [1] |
| \|022\|10/28 15:48:42 | \| Playing [/opt/lh/msgs/00000409.wav] |
| \|000\|10/28 15:48:42 | \| [Event: NCCEVN_PLACING_CALL] |
| \|000\|10/28 15:48:42 | \| [Event: NCCEVN_CALL_PROCEEDING] |
| \|000\|10/28 15:48:42 | \| Change line 0 status to [O] Outgoing from [D] |
| \|022\|10/28 15:48:44 | \| [Event: VCEEVN_PLAY_DONE, Finished , msec=2220] |
| \|022\|10/28 15:48:44 | \| [Unknown CTA Event: *** (20002003) v = 00000000] |
| \|022\|10/28 15:48:44 | \| CurrentStep: [2] [26] |
| \|022\|10/28 15:48:44 | \| SwitchMember Disconnect Port [22:0:1:22] from DSP |
| | [0:16:22] |
| \|705\|10/28 15:48:44 | \| SwitchMember Disconnect Port [22:0:1:22] from DSP |
| | [0:16:22] |
| \|022\|10/28 15:48:44 | \| SwitchMember Connect Port [22:0:0:22] to Member |
| | [0:0:33:0] \|705\|10/28 15:48:44 \| SwitchMember Connect Port [22:0:0:22] |
| | to Member [0:0:33:0] \|022\|10/28 15:48:44 \| [Unknown CTA Event: *** |
| | (20002003) v = 00000000] |
| \|022\|10/28 15:48:44 | \| CurrentStep: [3] [5] |
| \|022\|10/28 15:48:44 | \| Collect [2] DTMFs |
| \|000\|10/28 15:48:45 | \| [Event: NCCEVN_REMOTE_ALERTING] |
| \|000\|10/28 15:48:53 | \| [Event: NCCEVN_REMOTE_ANSWERED, |
| | NCC_ANSWER_SIGNAL] |
| \|000\|10/28 15:48:53 | \| [Event: NCCEVN_CALL_CONNECTED, |
| | \|000\|NCC_CON_VOICE_BEGIN] |
| \|000\|10/28 15:48:53 | \| [Unknown CTA Event: *** (20002003) v = 00000000] |
| \|000\|10/28 15:48:53 | \| CurrentStep: [1] [−1] |
| \|000\|10/28 15:48:53 | \| Send packet to SCP 127.0.0.1:6001 Type =Y |
| \|000\|10/28 15:48:53 | \| +------VRU->SCP-------- |
| \| PacketID: | [1] |
| \| TrxID: | [70] |
| \| Result: | [1] |
| \| Detail: | [1] |
| \| Data: | [ ] |
| \| Called: | [xxx6070237] |
| \| Calling: | [8772229054] |
| \| Port: | [0] |
| \| Attempts: | [0] |
| \| Status1: | [1] |
| \| Status2: | [39] |

+----------------------

| | |
|---|---|
| \|000\|10/28 15:48:53 | \| Received answer from SCP |
| \|000\|10/28 15:48:53 | \| +------Packet from SCP-------- |
| \| TrxID | [70] |
| \| MsgNum | [0] |
| \| AnsType | [N] |
| \| Action | [P] |
| \| MinLen | [0] |
| \| MaxLen | [0] |
| \| Beep | [1] |
| \| Flush | [Y] |
| \| Interrupt | [N] |
| \| TO1 | [8000] |
| \| TO2 | [3000] |
| \| Retries | [1] |
| \| Term | [#] |
| \| Erase | [*] |
| \| Special | [3] |
| \| Dnis | [ ] |
| \| Ani | [ ] |
| \| Data | [ ] |

+------Packet from SCP--------

Here, a caller is added to the conference call session.

| | |
|---|---|
| \|000\|10/28 15:48:53 | \| [Unknown CTA Event: *** (20002003) v = 00000000] |
| \|000\|10/28 15:48:53 | \| CurrentStep: [0] [10] |
| \|000\|10/28 15:48:53 | \| trying to get info for conf[2], ccid[70] |
| | member[1] |
| \|704\|10/28 15:48:53 | \| GetConfInfo( ) -> |
| | Allocated[5],Joined[1],flags[0],capabilities[124].user_data[0] |
| \|000\|10/28 15:48:54 | \| AddMember( )->Member [1] added to conference[2] |
| | totalmembers[2] port[0] |
| \|704\|10/28 15:48:54 | \| AddMember( )->Member [1] added to conference[2] |
| | totalmembers[2] port[0] |
| \|000\|10/28 15:48:54 | \| SwitchMember Disconnect Port [0:0:1:0] from DSP |
| | [0:16:0] |
| \|705\|10/28 15:48:54 | \| SwitchMember Disconnect Port [0:0:1:0] from DSP |
| | [0:16:0] |
| \|000\|10/28 15:48:54 | \| SwitchMember Connect Port [0:0:0:0] to Member |
| | [1:0:33:1] |
| \|705\|10/28 15:48:54 | \| SwitchMember Connect Port [0:0:0:0] to Member |
| | [1:0:33:1] |
| \|704\|10/28 15:48:54 | \| AddMember( ) ->ETD_EN[0:1:1] AGC_IO[0:0] |
| | \|704\|GAIN_IO[2:0] |
| \|000\|10/28 15:48:54 | \| AddMember( ) ->ETD_EN[0:1:1] AGC_IO[0:0] |
| | \|000\|GAIN_IO[2:0] |
| \|000\|10/28 15:48:54 | \| AddMember( )->Tone[1] Success. CONF->[2] |
| \|704\|10/28 15:48:54 | \| AddMember( )->Tone [1]Sucess. CONF->[2] |
| \|000\|10/28 15:48:54 | \| Change line 0 status to [C] Conferenced from [O] |
| \|000\|10/28 15:48:54 | \| [Unknown CTA Event: *** (20002003) v = 00000000] |
| \|000\|10/28 15:48:54 | \| CurrentStep: [1] [−1] |
| \|000\|10/28 15:48:54 | \| Send packet to SCP 127.0.0.1:6001 Type =Y |
| \|000\|10/28 15:48:54 | \| +------VRU->SCP-------- |
| \| PacketID: | [1] |
| \| TrxID: | [70] |
| \| Result: | [1] |
| \| Detail: | [0] |
| \| Data: | [ ] |
| \| Called: | [6146070237] |
| \| Calling: | [8772229054] |
| \| Port: | [0] |
| \| Attempts: | [0] |
| \| Status1: | [2] |
| \| Status2: | [0] |

+----------------------

| | |
|---|---|
| \|000\|10/28 15:48:54 | \| Received answer from SCP |
| \|000\|10/28 15:48:54 | \| +------Packet from SCP-------- |
| \| TrxID | [70] |
| \| MsgNum | [0] |
| \| AnsType | [D] |
| \| Action | [N] |
| \| MinLen | [2] |
| \| MaxLen | [2] |
| \| Beep | [0] |
| \| Flush | [Y] |
| \| Interrupt | [Y] |
| \| TO1 | [0] |
| \| TO2 | [3000] |
| \| Retries | [1] |
| \| Term | [#] |
| \| Erase | [A] |
| \| Special | [0] |
| \| Dnis | [ ] |
| \| Ani | [ ] |
| \| Data | [ ] |

+------Packet from SCP--------

Here, a session participant is removed from the current conference call session.

| | |
|---|---|
| \|000\|10/28 15:48:54 | \| [Unknown CTA Event: *** (20002003) v = 00000000] |
| \|000\|10/28 15:48:54 | \| CurrentStep: [0] [5] |
| \|000\|10/28 15:48:54 | \| Collect [2] DTMFs |
| \|022\|10/28 15:49:16 | \| [Event: ADIEVN_COLLECTION_DONE, Released |
| | digit string = ‘’] |
| \|022\|10/28 15:49:16 | \| [Unknown CTA Event: *** (20002002) v = 00000000] |
| \|022\|10/28 15:49:16 | \| Change line 22 status to [2] Transition from [C] |
| \|022\|10/28 15:49:16 | \| Change line 22 status to [R] Ready from [2] |
| \|022\|10/28 15:49:16 | \| USREVN_HANGUP State [Connected] Pending [None] |
| \|022\|10/28 15:49:16 | \| [Event: NCCEVN_CALL_DISCONNECTED, NCC_DIS_SIGNAL] |
| \|022\|10/28 15:49:16 | \| Change line 22 status to [2] Transition from [R] |
| \|022\|10/28 15:49:16 | \| Release the call |
| \|022\|10/28 15:49:16 | \| [Event: NCCEVN_CALL_RELEASED] |
| \|022\|10/28 15:49:16 | \| SwitchMember DisConnect Port [22:0:0:22] from |
| | Member [0:0:33:0] |
| \|705\|10/28 15:49:16 | \| SwitchMember DisConnect Port [22:0:0:22] from |
| | Member [0:0:33:0] |
| \|022\|10/28 15:49:16 | \| SwitchMember Connect Port [22:0:1:22] to DSP |
| | \|022\| [0:16:22] |
| \|705\|10/28 15:49:16 | \| SwitchMember Connect Port [22:0:1:22] to DSP |
| | [0:16:22] |
| \|704\|10/28 15:49:16 | \| RemoveMember( )->Switching Success |
| \|022\|10/28 15:49:16 | \| RemoveMember( )->Member[0] removed from |
| | conference[2] number of members[1] |
| \|704\|10/28 15:49:16 | \| RemoveMember( )->Member[0] removed from |
| | conference[2] number of members[1] Port [22] |
| \|704\|10/28 15:49:16 | \| RemoveMember( )->Tone[2] Sucess. CONF->[2] |
| \|022\|10/28 15:49:16 | \| Call Released − Duration = 64 Seconds |
| \|022\|10/28 15:49:16 | \| Send packet to SCP 127.0.0.1:6001 Type =N |
| \|022\|10/28 15:49:16 | \| +------VRU->SCP-------- |
| \| PacketID: | [1] |
| \| TrxID: | [70] |
| \| Result: | [1] |
| \| Detail: | [2] |
| \| Data: | [ ] |
| \| Called: | [9054] |
| \| Calling: | [6148180284] |
| \| Port: | [22] |
| \| Attempts: | [1] |
| \| Status1: | [6] |
| \| Status2: | [44] |

+----------------------

Lastly, the conference call session is terminated.

| | |
|---|---|
| \|022\|10/28 15:49:16 | \| Change line 22 status to [R] Ready from [2] |
| \|000\|10/28 15:49:18 | \| [Event: ADIEVN_COLLECTION_DONE, Released |
| | digit string = ‘’] |
| \|000\|10/28 15:49:18 | \| [Unknown CTA Event: *** (20002002) v = 00000000] |
| \|000\|10/28 15:49:18 | \| Change line 0 status to [2] Transition from [C] |
| \|000\|10/28 15:49:18 | \| Change line 0 status to [M] Reserved from [2] |
| \|000\|10/28 15:49:18 | \| USREVN_HANGUP State [Connected] Pending [None] |
| \|000\|10/28 15:49:18 | \| [Event: NCCEVN_CALL_DISCONNECTED, NCC_DIS_SIGNAL] |
| \|000\|10/28 15:49:18 | \| Change line 0 status to [2] Transition from [M] |
| \|000\|10/28 15:49:18 | \| Release the call |
| \|000\|10/28 15:49:18 | \| [Event: NCCEVN_CALL_RELEASED] |
| \|000\|10/28 15:49:18 | \| SwitchMember DisConnect Port [0:0:0:0] from |
| | Member |
| | [1:0:33:1] |
| \|705\|10/28 15:49:18 | \| SwitchMember DisConnect Port [0:0:0:0] from |
| | Member |
| | [1:0:33:1] |
| \|000\|10/28 15:49:18 | \| SwitchMember Connect Port [0:0:1:0] to DSP |
| | \|000\|[0:16:0] |
| \|705\|10/28 15:49:18 | \| SwitchMember Connect Port [0:0:1:0] to DSP |
| | \|705\|[0:16:0] |
| \|704\|10/28 15:49:18 | \| RemoveMember( )->Switching Success |
| \|000\|10/28 15:49:18 | \| RemoveMember( )->Member[1] removed from |
| | conference[2] number of members[0] |
| \|704\|10/28 15:49:18 | \| RemoveMember( )->Member[1] removed from |
| | conference[2] number of members[0] Port [0] |
| \|704\|10/28 15:49:18 | \| RemoveMember( )->No Tone Conf Empty. CONF->[2] |
| \|000\|10/28 15:49:18 | \| Call Released − Duration = 25 Seconds |
| \|000\|10/28 15:49:18 | \| Send packet to SCP 127.0.0.1:6001 Type =N |
| \|000\|10/28 15:49:18 | \| +------VRU->SCP-------- |
| \| PacketID: | [1] |
| \| TrxID: | [70] |
| \| Result: | [1] |
| \| Detail: | [2] |
| \| Data: | [ ] |
| \| Called: | [6146070237] |
| \| Calling: | [8772229054] |
| \| Port: | [0] |
| \| Attempts: | [1] |
| \| Status1: | [3] |
| \| Status2: | [44] |
| +---------------------- | |
| \|000\|10/28 15:49:18 | \| Change line 0 status to [R] Ready from [2] |
| \|702\|10/28 15:49:18 | \| Accept a connection |
| \|702\|10/28 15:49:18 | \| [014] Start CONNECTION thread |
| \|702\|10/28 15:49:18 | \| +------SCP->VRU-------- |
| \| TrxID: | [70] |
| \| Command: | [9] |
| \| Data: | [ ] |

+----------------------

| | |
|---|---|
| \|704\|10/28 15:49:18 | \| Index[2] LRT [−1] LRT Status [&] RecordDone [38] |
| | Handle [329000] |
| \|704\|10/28 15:49:18 | \| ATTEMPT->Close Conf [TRXID, CCID, Index] [70:70:2] |
| \|704\|10/28 15:49:18 | \| [Unknown CTA Event: *** (20002006) v = 00000000] |
| \|704\|10/28 15:49:18 | \| SUCCESS->Close Conf [CCID:INDEX] [70:2] |
| \|702\|10/28 15:49:18 | \| +------VRU->SCP-------- |
| \| TrxID: | [70] |
| \| Result: | [1] |
| \| ErrorCode: | [0] |
| \| Data: | [1024] |

+----------------------

| | |
|---|---|
| \|702\|10/28 15:49:18 | \| [014] Closing connection |
| \|702\|10/28 15:49:18 | \| [014] Terminate CONNECTION thread |

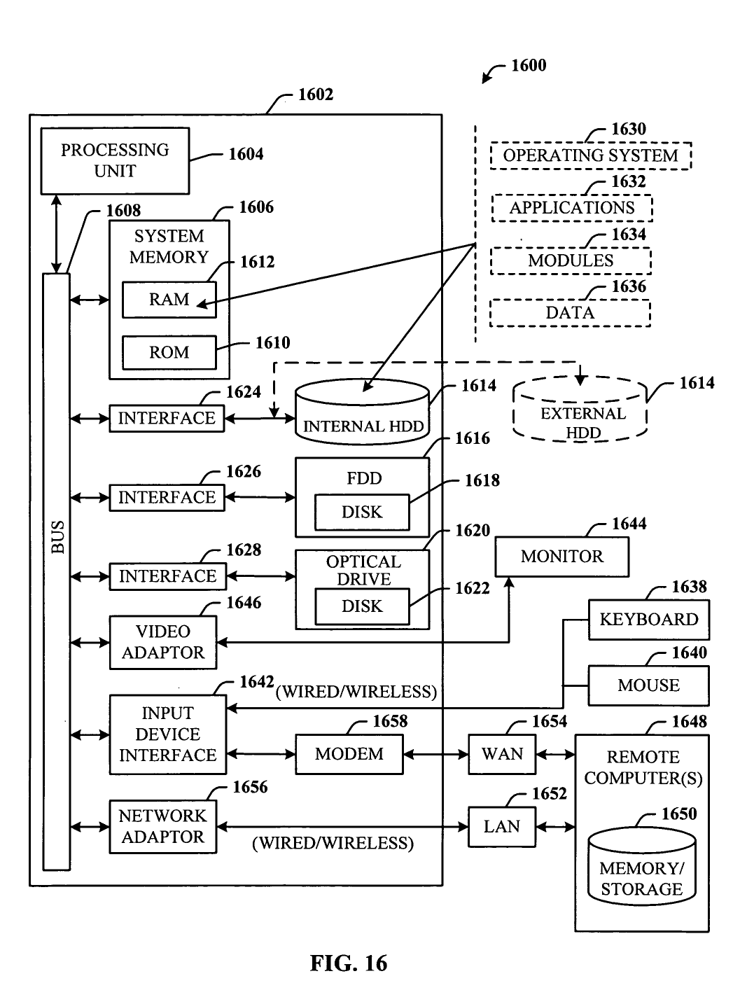

Referring now to FIG. 16, there is illustrated a block diagram of a computer operable to execute the disclosed architecture. In order to provide additional context for various aspects of the subject invention, FIG. 16 and the following discussion are intended to provide a brief, general description of a suitable computing environment 1600 in which the various aspects of the invention can be implemented. While the invention has been described above in the general context of computer-executable instructions that may run on one or more computers, those skilled in the art will recognize that the invention also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the invention may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer readable media can comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 16, there is illustrated an exemplary environment 1600 for implementing various aspects of the invention that includes a computer 1602, the computer 1602 including a processing unit 1604, a system memory 1606 and a system bus 1608. The system bus 1608 couples system components including, but not limited to, the system memory 1606 to the processing unit 1604. The processing unit 1604 can be any of various commercially available processors. Dual microprocessors and other multi-processor architectures may also be employed as the processing unit 1604.

The system bus 1608 can be any of several types of bus structure that may further interconnect to a memory bus (with or without a memory controller), a peripheral bus, and a local bus using any of a variety of commercially available bus architectures. The system memory 1606 includes read only memory (ROM) 1610 and random access memory (RAM) 1612. A basic input/output system (BIOS) is stored in a non-volatile memory 1610 such as ROM, EPROM, EEPROM, which BIOS contains the basic routines that help to transfer information between elements within the computer 1602, such as during start-up. The RAM 1612 can also include a high-speed RAM such as static RAM for caching data.

The computer 1602 further includes an internal hard disk drive (HDD) 1614 (e.g., EIDE, SATA), which internal hard disk drive 1614 may also be configured for external use in a suitable chassis (not shown), a magnetic floppy disk drive (FDD) 1616, (e.g., to read from or write to a removable diskette 1618) and an optical disk drive 1620, (e.g., reading a CD-ROM disk 1622 or, to read from or write to other high capacity optical media such as the DVD). The hard disk drive 1614, magnetic disk drive 1616 and optical disk drive 1620 can be connected to the system bus 1608 by a hard disk drive interface 1624, a magnetic disk drive interface 1626 and an optical drive interface 1628, respectively. The interface 1624 for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer 1602, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the invention.

A number of program modules can be stored in the drives and RAM 1612, including an operating system 1630, one or more application programs 1632, other program modules 1634 and program data 1636. All or portions of the operating system, applications, modules, and/or data can also be cached in the RAM 1612. It is appreciated that the invention can be implemented with various commercially available operating systems or combinations of operating systems.

A user can enter commands and information into the computer 1602 through one or more wired/wireless input devices, e.g., a keyboard 1638 and a pointing device, such as a mouse 1640. Other input devices (not shown) may include a microphone, an IR remote control, a joystick, a game pad, a stylus pen, touch screen, or the like. These and other input devices are often connected to the processing unit 1604 through an input device interface 1642 that is coupled to the system bus 1608, but can be connected by other interfaces, such as a parallel port, an IEEE 1394 serial port, a game port, a USB port, an IR interface, etc.

A monitor 1644 or other type of display device is also connected to the system bus 1608 via an interface, such as a video adapter 1646. In addition to the monitor 1644, a computer typically includes other peripheral output devices (not shown), such as speakers, printers, etc.

The computer 1602 may operate in a networked environment using logical connections via wired and/or wireless communications to one or more remote computers, such as a remote computer(s) 1648. The remote computer(s) 1648 can be a workstation, a server computer, a router, a personal computer, portable computer, microprocessor-based entertainment appliance, a peer device or other common network node, and typically includes many or all of the elements described relative to the computer 1602, although, for purposes of brevity, only a memory storage device 1650 is illustrated. The logical connections depicted include wired/wireless connectivity to a local area network (LAN) 1652 and/or larger networks, e.g., a wide area network (WAN) 1654. Such LAN and WAN networking environments are commonplace in offices, and companies, and facilitate enterprise-wide computer networks, such as intranets, all of which may connect to a global communication network, e.g., the Internet.

When used in a LAN networking environment, the computer 1602 is connected to the local network 1652 through a wired and/or wireless communication network interface or adapter 1656. The adaptor 1656 may facilitate wired or wireless communication to the LAN 1652, which may also include a wireless access point disposed thereon for communicating with the wireless adaptor 1656.

When used in a WAN networking environment, the computer 1602 can include a modem 1658, or is connected to a communications server on the WAN 1654, or has other means for establishing communications over the WAN 1654, such as by way of the Internet. The modem 1658, which can be internal or external and a wired or wireless device, is connected to the system bus 1608 via the serial port interface 1642. In a networked environment, program modules depicted relative to the computer 1602, or portions thereof, can be stored in the remote memory/storage device 1650. It will be appreciated that the network connections shown are exemplary and other means of establishing a communications link between the computers can be used.

The computer 1602 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

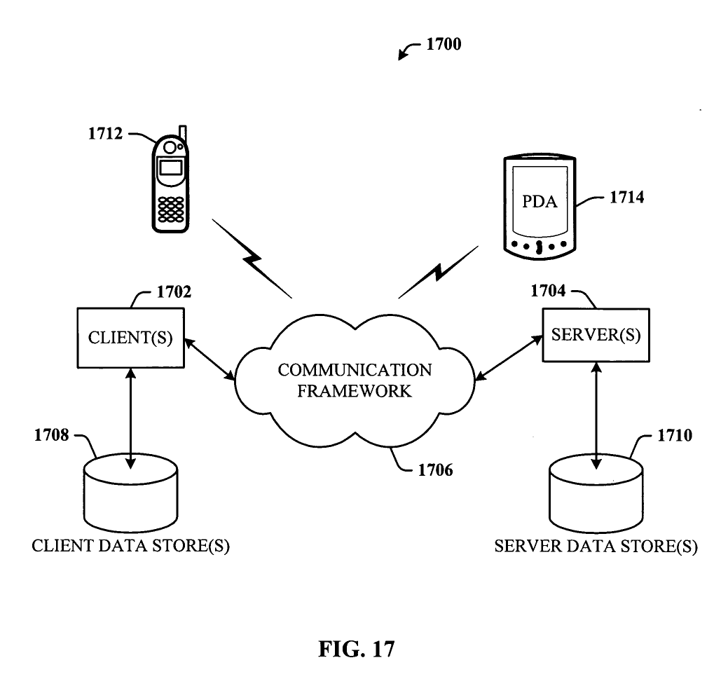

Referring now to FIG. 17, there is illustrated a schematic block diagram of an exemplary computing environment 1700 in accordance with the subject invention. The system 1700 includes one or more client(s) 1702. The client(s) 1702 can be hardware and/or software (e.g., threads, processes, computing devices). The client(s) 1702 can house cookie(s) and/or associated contextual information by employing the invention, for example.

The system 1700 also includes one or more server(s) 1704. The server(s) 1704 can also be hardware and/or software (e.g., threads, processes, computing devices). The servers 1704 can house threads to perform transformations by employing the invention, for example. One possible communication between a client 1702 and a server 1704 can be in the form of a data packet adapted to be transmitted between two or more computer processes. The data packet may include a cookie and/or associated contextual information, for example. The system 1700 includes a communication framework 1706 (e.g., a global communication network such as the Internet) that can be employed to facilitate communications between the client(s) 1702 and the server(s) 1704.

Communications can be facilitated via a wired (including optical fiber) and/or wireless technology. The client(s) 1702 are operatively connected to one or more client data store(s) 1708 that can be employed to store information local to the client(s) 1702 (e.g., cookie(s) and/or associated contextual information). Similarly, the server(s) 1704 are operatively connected to one or more server data store(s) 1710 that can be employed to store information local to the servers 1704. Devices such as a cellular telephone 1712 and a PDA 1714 can connect and/or participate in a call conferencing session.

Note that the architecture of the subject invention is not limited to call (or voice) conferencing, but also includes the capability of vide conferencing such that images are transmitted and present to participants during the session.

What has been described above includes examples of the invention. It is, of course, not possible to describe every conceivable combination of components or methodologies for purposes of describing the subject invention, but one of ordinary skill in the art may recognize that many further combinations and permutations of the invention are possible. Accordingly, the invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A system that facilitates call processing, comprising:
a voice response component that interfaces to a digital telephone communications system to communicate voice messages, the voice response component including a non-voice communications bus; and
a session component that interfaces to the voice response component to manage processing of the voice messages by routing the voice messages along the non-voice communications bus to facilitate managing a call session.

2. The system of claim 1, wherein the call session is a conference call session.

3. The system of claim 1, wherein the non-voice communications bus facilitates communications according to an MVIP (Multi-Vendor Integration Protocol) architecture.

4. The system of claim 1, wherein the non-voice communications bus facilitates communications according to at least one of an H.100 bus and an H.110 bus architecture.

5. The system of claim 1, further comprising an access component that facilitates user interaction via a browser from a remote location.

6. The system of claim 1, wherein the session component facilitates management of digital processing resources of the voice response component by assigning session calls thereto.

7. The system of claim 6, wherein the digital processing resources include digital signal processors.

8. The system of claim 6, wherein the session component facilitates dedicating select ones of the digital signal processors to perform noise cancellation, volume control, and echo cancellation.

9. The system of claim 1, wherein the session component facilitates dynamically assigning incoming call lines to digital resources.

10. A computer that employs the system of claim 1.

11. A web-based server that employs the system of claim 1.

12. The system of claim 1, wherein a plurality of session participants are called substantially simultaneously to be brought into the call session.

13. The system of claim 1, wherein a new session participant is called, prompted for a custom greeting, the custom greeting recorded, and replayed to existing session participants.

14. The system of claim 1, wherein a PIN of a new participant is processed to bind the new participant into the call session.

15. The system of claim 1, wherein a PIN of a caller is processed to create a new conference call session.

16. The system of claim 1, wherein the voice response component automatically recognizes a facsimile signal and facilitates processing of contents thereof for storage in a database.

17. The system of claim 16, wherein the contents of the facsimile are automatically recognized and stored as text in the database.

18. The system of claim 1, wherein the voice response component automatically receives and facilitates storage in a flat file a telephone number of a caller.

19. The system of claim 1, wherein a group of people can be invited to the call session in response to a single user input action via a graphical user interface (GUI).

20. The system of claim 19, wherein data representative of the group of people is associated with an e-mail address book such that selection of a corresponding group of names automatically effects communication of an invitation to join the call session.

21. The system of claim 1, wherein a session caller using a first telephone to interact with the call session can switch from the first telephone to a second telephone that connects to the call session without interruption during the call session.

22. The system of claim 1, wherein the session component facilitates starting the call session only after a session host has logged in.

23. The system of claim 1, wherein the session component facilitates starting the call session when a non-host participant has logged in.

24. A system that facilitates call processing, comprising:
a voice response component that interfaces to a digital telephone communications system to communicate voice messages, the voice response component including an MVIP-based non-voice communications bus;
a session component that interfaces to the voice response component to manage processing of the voice messages by routing the voice messages along the non-voice communications bus to facilitate managing a conference call session; and
a web-based access component that facilitates remote access to the session component via a GUI.

25. The system of claim 24, wherein the non-voice communications bus facilitates communications according to at least one of an H.100 bus and an H.110 bus architecture.

26. The system of claim 24, wherein a plurality of session participants are called substantially simultaneously to be brought into the conference call session.

27. The system of claim 24, wherein the voice response component automatically recognizes a facsimile signal and facilitates processing of the contents thereof for storage in a database as a text file.

28. The system of claim 24, wherein the a group of people can be invited to the call session in response to a single user input action via the GUI and data representative of the group of people is associated with an e-mail address book such that selection of a corresponding group of names automatically effects communication of an invitation to join the call session.

29. The system of claim 24, wherein a session caller using a first telephone to interact with the call session can switch from the first telephone to a second telephone that connects to the call session without interruption during the call session.

30. A method of managing a conference call, comprising:
communicating telephone calls via multiple call lines of a telephone communications system, the multiple call lines associated with a first call processing component;
dynamically assigning the telephone calls to a digital resource of a second call processing component;
routing the telephone calls from the first call processing component to the second call processing resource across a non-voice communications bus; and
processing the telephone calls as a conference call session.

31. The method of claim 30, further comprising dynamically allocating and de-allocating ports of the digital resource to facilitate the conference call session.

32. The method of claim 30, further comprising allocating a second digital resource to facilitate echo cancellation.

33. The method of claim 30, further comprising allocating a second digital resource to facilitate noise cancellation.

34. The method of claim 30, further comprising allocating a second digital resource to facilitate volume control.

35. The method of claim 30, the first and second call processing components each includes a plurality of digital resources that are dynamically allocated and de-allocated in accordance with a number of the telephone calls.

36. The method of claim 30, further comprising dialing session participants substantially dynamically and binding the session participants into the conference call session.

37. The method of claim 30, further comprising that acts of:
calling a new participant over one of the multiple call lines;
prompting the new participant to input a custom message;
recording the custom message; and
replaying the custom message to existing participants of the call session.

38. The method of claim 30, further comprising the acts of:
receiving a call from a new participant;
prompting the new participant for a PIN;
validating the PIN; and
binding the new participant into the call session.

39. The method of claim 30, further comprising the acts of:
receiving a call from a new participant over one of the multiple call lines;
prompting the new participant for a PIN;
validating the PIN; and
creating a new conference call session.

40. The method of claim 30, further comprising the acts of:
receiving a call over one of the multiple call lines;
detecting that the call is a facsimile signal;
processing facsimile information of the facsimile signal; and
automatically writing the facsimile information to a data store.

41. The method of claim 30, further comprising the acts of:
receiving a call of a caller over one of the multiple call lines;
prompting the caller for a PIN; and
writing a telephone number associated with the call and the PIN to a flat file.

42. The method of claim 30, further comprising the acts of:
grouping usernames as a group;
selecting the group; and
automatically calling each user associated with the respective username in response to a single input command.

43. The method of claim 30, further comprising at least one of adding, dropping, and muting a session participant at any time via a GUI.

44. The method of claim 30, further comprising automatically sending a session reminder via e-mail.

45. A method of managing a conference call, comprising:
communicating telephone calls via multiple call lines of a telephone communications system, the multiple call lines associated with a first call processing component that communicates over common non-voice communications bus;
dynamically assigning a subset of the telephone calls to a second digital resource of a second call processing component;
routing the telephone calls from the first call processing component to the second call processing resource across the non-voice communications bus;
processing the subset of telephone calls as a conference call session; and
dynamically allocating and de-allocating ports of the second digital resource to facilitate the conference call session.

46. The method of claim 45, further comprising dialing session participants substantially dynamically and binding the session participants into the conference call session.

47. The method of claim 45, further comprising binding received telephone calls into the call session.
